(19) United States
(12) Patent Application Publication
(10) Pub. No.: US 2026/0249112 A1
(43) Pub. Date: Aug. 27, 2026

(54) ADAPTER FOR RESPIRATOR FIT TESTING

(71) Applicant: OHD, LLLP, Birmingham, AL (US)

(72) Inventors: Jeffery Griggs, Pelham, AL (US); Luther Allen, Birmingham, AL (US)

(73) Assignee: OHD, LLLP, Birmingham, AL (US)

(21) Appl. No.: 19/548,534

(22) Filed: Feb. 24, 2026

Related U.S. Application Data
(60) Provisional application No. 63/762,332, filed on Feb. 24, 2025.

(51) Int. Cl. A62B 27/00; G01M 3/02

(52) U.S. Cl. CPC A62B 27/00; G01M 3/02

(57) ABSTRACT

Adapters that provide connection between a respirator and a respirator fit testing device, and converters designed to provide universal compatibility between the adapter and any of the commercially available respirators.

### CROSS-REFERENCE TO RELATED APPLICATIONS

This application claims priority to U.S. Provisional Patent Application Serial No. 63/762,332 filed Feb. 24, 2025, the contents of which are incorporated herein in their entirety.

### FIELD OF THE INVENTION

This disclosure generally relates to the field of respirators, and more particularly, respirator adapters for respirator fit testing.

### BACKGROUND

The use of respirators is required by several national and international standards, including the Occupational Safety and Health Administration (OSHA) in the United States when hazardous substances in the air cannot be controlled to an acceptable level for the health of employees. As a result, millions of individuals who may encounter inhalation hazards on the job rely on respirators.

According to OSHA, to ensure a respirator provides an appropriate level of protection, it is necessary that employers develop and maintain a respiratory protection program, of which respirator fit testing is a core concept. A respirator fit test evaluates the fit of a respirator to a wearer. A respirator fit test may ensure a respirator wearer is using an appropriate model, style, and size respirator, as tight-fitting respirators are necessary to avoid health concerns caused by the inhalation of contaminants due to poor seals, fittings, and other complications. Properly and tight-fitting respirators are necessary to avoid health concerns caused by the inhalation of contaminants due to poor seals, fittings, and other complications.

Fit testing may be performed qualitatively using a test agent detectable by the wearer, such as via the wearer’s sense of taste, smell, or reaction to an irritant. Fit testing may also be performed quantitatively using an instrument to measure leakage of a test agent.

Condensation nuclei counting (CNC) is a type of quantitative fit testing utilizing airborne particles to measure respirator leakage. CNC fit testing ensures proper fitting of the respirators to avoid health concerns caused by the inhalation of contaminants due to poor seals, fittings, and other complications.

Depending upon the type of respirator, an adapter may be necessary to connect the respirator to a fit testing device in order to properly conduct a respirator fit test. A piece of tubing may be connected at one end to the fit test device and at the other end to an adapter wherein particle count inside the respirator may be measured. and Each respirator manufacturer or brand may have a different type of attachment from the respirator to the adapter.

### BRIEF SUMMARY

Traditional adapters for connecting a respirator to a fit testing device are typically specific to each brand or manufacturer, as different brands often use unique attachment mechanisms. This results in substantial costs and challenges in obtaining the right adapter for each respirator being tested. Moreover, conventional adapters feature an offset connection for the tubing that conveys aerosol from inside the mask to the respirator fit test device. The location and positioning of this offset connection make it challenging to properly attach the tubing.

The adapters and converters disclosed herein offer solutions to these aforementioned difficulties by providing a universal adapter and selection of various converters that enable seamless connection between any respirator and a fit testing device, regardless of the brand, type, or manufacturer. Accordingly, the present disclosure provides improved adapters with a centrally positioned fitting, and a range of respirator specific converters. As such, the disclosed adapters and converters of the present disclosure provide universal compatibility.

The present disclosure provides an apparatus comprising an adapter having a second end configured for removable attachment to a filter and a first end configured for removeable attachment to a converter, such as a second end of the converter. A first end of the converter is configured for attachment to a respirator.

The present disclosure further provides a method of performing a respirator fit test utilizing the adapter and a respirator specific converter of the present disclosure. The method may include threading a piece of tubing from the centrally positioned fitting of the adapter through a valve of the respirator. The method may include connecting a piece of tubing to an outlet of the adapter to the respirator fit test device. The method may include donning or putting on the respirator and performing a respirator fit test. The method may include trimming the tubing to an appropriate length depending on the distance from the centrally located fitting to the interior of the respirator. Performing the fit test may include performing a controlled negative pressure fit test.

The present disclosure further yet provides methods of manufacturing an adapter and a converter of the present disclosure. The present disclosure also provides a kit including one or more of any of the adapters of the present disclosure, a converter of the present disclosure, and a piece of tubing.

### DESCRIPTION OF THE DRAWINGS

It is to be understood that both the foregoing summary and the following drawings and detailed description may be exemplary and may not be restrictive of the aspects of the present disclosure as claimed. Certain details may be set forth to provide a better understanding of various features, aspects, and advantages of the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention. Like numerals represent like features of the various embodiments of the invention presented in the description and drawings. Moreover, the features and components presented in the drawings, unless stated to be otherwise, are not necessarily drawn to scale.

The present disclosure may be better understood by reference to the accompanying drawing sheets, in which:

FIG. 1 includes a prior art adapter.

FIG. 2 includes an adapter attached to a converter in accordance with certain aspects of the present disclosure.

FIG. 3A includes an adapter body in accordance with certain aspects of the present disclosure.

FIG. 3B includes an adapter in accordance with certain aspects of the present disclosure.

FIG. 4 includes a male bayonet attachment mechanism in accordance with certain aspects of the present disclosure.

FIG. 5 includes a female bayonet attachment mechanism in accordance with certain aspects of the present disclosure.

FIG. 6A includes an adapter in accordance with certain aspects of the present disclosure.

FIG. 6B includes a platform of the adapter in accordance with certain aspects of the present disclosure.

FIG. 7 includes an adapter attached to a converter in accordance with certain aspects of the present disclosure.

FIG. 8 includes an exploded side view of an adapter in accordance with certain aspects of the present disclosure.

FIG. 9 includes an exploded top perspective view of an adapter in accordance with certain aspects of the present disclosure.

FIG. 10 includes a top (first converter end) view of the adapter shown in FIG. 1.

FIG. 11 includes an exploded view of an adapter in accordance with certain aspects of the present disclosure.

FIG. 12 includes a cross-sectional view of the adapter attached to a converter shown in FIG. 1.

FIG. 13A includes a cross-sectional view of a converter in accordance with certain aspects of the present disclosure.

FIG. 13B includes a converter in accordance with certain aspects of the present disclosure.

FIG. 13C includes a converter in accordance with certain aspects of the present disclosure.

FIG. 14A includes a cross-sectional view of a converter in accordance with certain aspects of the present disclosure.

FIG. 14B includes a converter in accordance with certain aspects of the present disclosure.

FIG. 15A includes a cross-sectional view of a converter in accordance with certain aspects of the present disclosure.

FIG. 15B includes a converter in accordance with certain aspects of the present disclosure.

FIG. 16A includes a cross-sectional view of a converter in accordance with certain aspects of the present disclosure.

FIG. 16B includes a converter in accordance with certain aspects of the present disclosure.

FIG. 17A includes a cross-sectional view of a converter in accordance with certain aspects of the present disclosure.

FIG. 17B includes a converter in accordance with certain aspects of the present disclosure.

FIG. 18A includes a cross-sectional view of a converter in accordance with certain aspects of the present disclosure.

FIG. 18B includes a converter in accordance with certain aspects of the present disclosure.

FIG. 18C includes a converter in accordance with certain aspects of the present disclosure.

FIG. 19A includes a cross-sectional view of a converter in accordance with certain aspects of the present disclosure.

FIG. 19B includes a converter in accordance with certain aspects of the present disclosure.

FIG. 20A includes a cross-sectional view of a converter in accordance with certain aspects of the present disclosure.

FIG. 20B includes a converter in accordance with certain aspects of the present disclosure.

FIG. 20C includes a top (first converter end) view of the converter of FIGS. 20A & 20B.

FIG. 21A includes a cross-sectional view of a converter in accordance with certain aspects of the present disclosure.

FIG. 21B includes a converter in accordance with certain aspects of the present disclosure.

FIG. 22A includes a cross-sectional view of a converter in accordance with certain aspects of the present disclosure.

FIG. 22B includes a converter in accordance with certain aspects of the present disclosure.

FIG. 23A includes a cross-sectional view of a converter in accordance with certain aspects of the present disclosure.

FIG. 23B includes a converter in accordance with certain aspects of the present disclosure.

FIG. 24A includes a cross-sectional view of a converter in accordance with certain aspects of the present disclosure.

FIG. 24B includes a converter in accordance with certain aspects of the present disclosure.

FIG. 25A includes a cross-sectional view of a converter in accordance with certain aspects of the present disclosure.

FIG. 25B includes a converter in accordance with certain aspects of the present disclosure.

FIG. 26A includes a cross-sectional view of a converter in accordance with certain aspects of the present disclosure.

FIG. 26B includes a converter in accordance with certain aspects of the present disclosure.

FIG. 27A includes a cross-sectional view of a converter in accordance with certain aspects of the present disclosure.

FIG. 27B includes a converter in accordance with certain aspects of the present disclosure.

FIG. 28 includes an exploded view of a filter, adapter, converter, first respirator tubing, second respirator tubing, and respirator in accordance with certain aspects of the present disclosure.

### DETAILED DESCRIPTION

The present disclosure generally describes a universal adapter for respirator fit testing, wherein a converter may be removably attached to the adapter, wherein the adapter is removably attached to a fit test device, and wherein the converter has an attachment mechanism corresponding to an attachment mechanism of a respirator. The present disclosure provides kits including, one or more of, an adapter for a respirator, a converter capable of attaching to the adapter, and at least one respirator tubing.

It is understood, however, that this disclosure also embraces numerous alternative features, aspects, and advantages that may be accomplished by combining any of the various features, aspects, and/or advantages described herein in any combination or sub-combination that one of ordinary skill in the art may find useful. Such combinations or sub-combinations are intended to be included within the scope of this disclosure. As such, the claims may be amended to recite any features, aspects, and advantages expressly or inherently described in, or otherwise expressly or inherently supported by this disclosure. Further, any features, aspects, and advantages that may be present in the prior art may be affirmatively disclaimed. Accordingly, this disclosure may comprise, consist of, consist essentially of, or be characterized by one or more of the features, aspects, and advantages described herein.

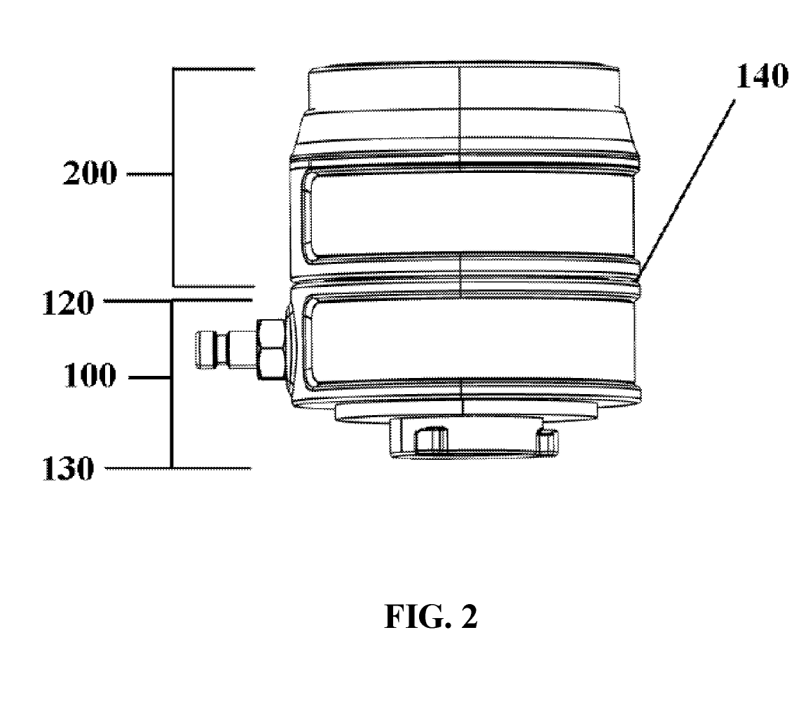

The present disclosure provides an adapter for respirator fit testing. The adapter 100 may include a body defined by a first end 120 and a second end 130 (FIGS. 2 & 3A).

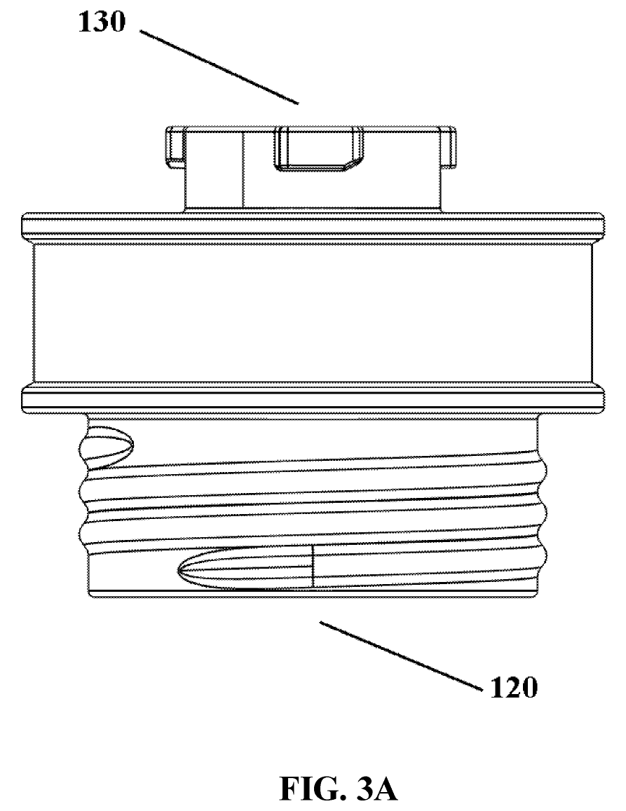

The first end 120 may be configured to attach to a respirator or a converter 200 (FIG. 2). The first end 120 may removably attach to the respirator or the converter 200 via an attachment mechanism 140. An attachment mechanism 140 may include male 150 or females 160 threads capable of threadedly attaching to corresponding male 150 or female 160 threads of an attachment mechanism (FIG. 3B). As used herein, a “female thread” refers to at least one grove on the inside of converter or adapter. As used herein, a “male thread” refers to at least one grove externally placed on a converter or adapter.

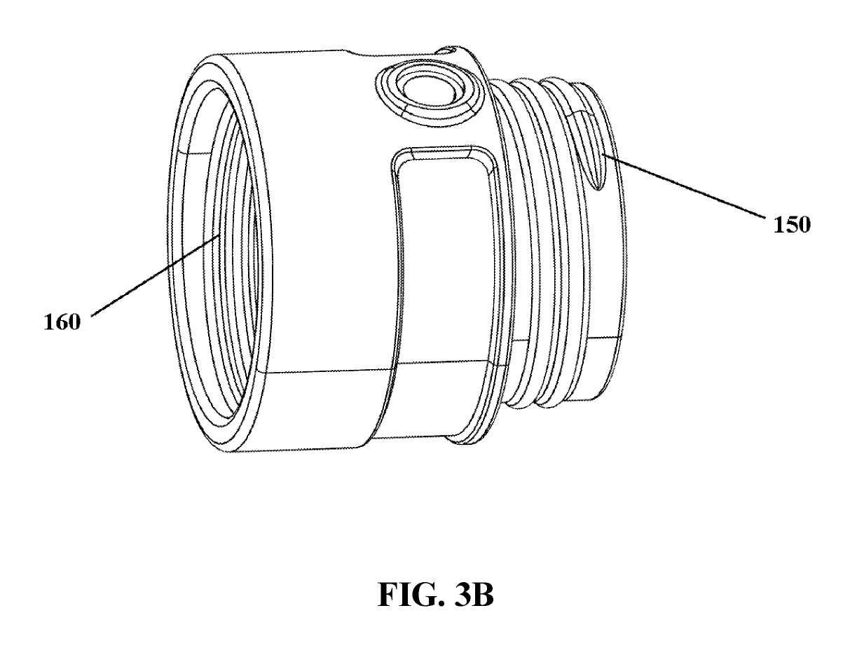

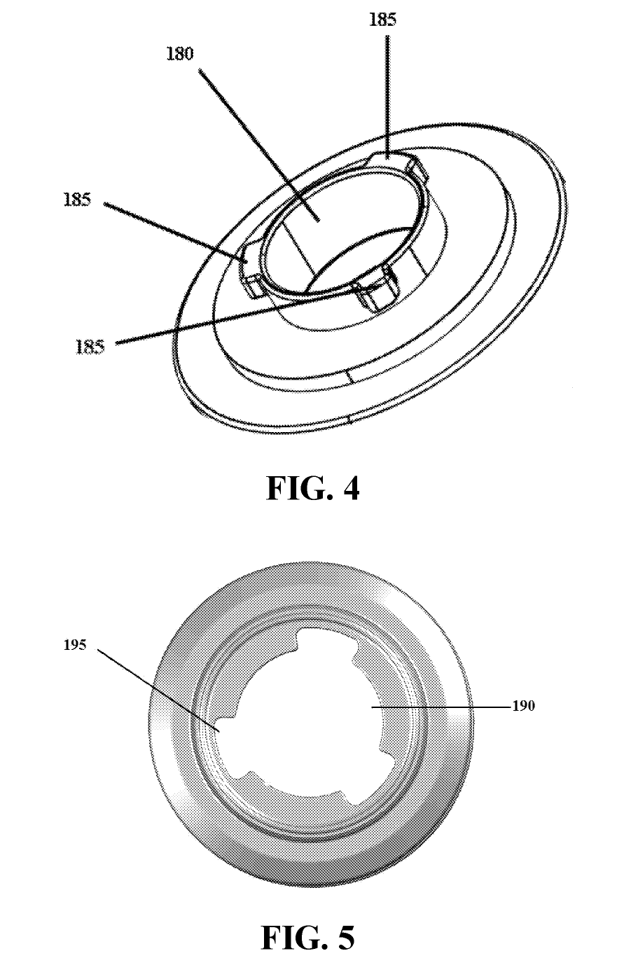

An attachment mechanism 140 may include a bayonet connection 170 including a male locking ring 180 with one or more pegs 185 and a female receptor 190 with one or more slots 195 capable of receiving the one or more radial pegs 185 (FIGS. 4 & 5). When the radial pegs 185 of the locking ring 180 are received within the slots 195 of the female receptor 190, the locking ring 180 may be rotated within the receptor 190 so that the connection is locked in place. Pressure and rotation in the opposite direction than used for connection may release the bayonet connection 170. As used herein, a bayonet connection 170 is generally known in the art, and one of skill in the art may utilize a similar type connection or a bayonet connection 170 of various numbers of pegs or dimensions depending upon the desired respirator and/or desired attachment mechanism.

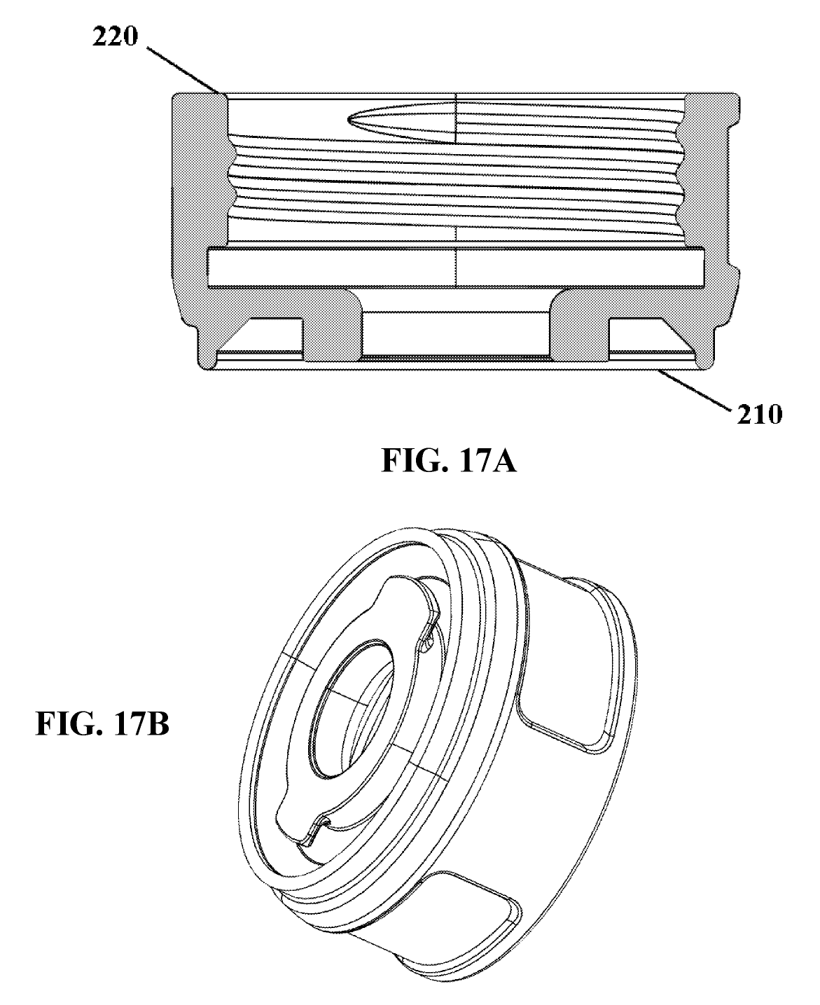

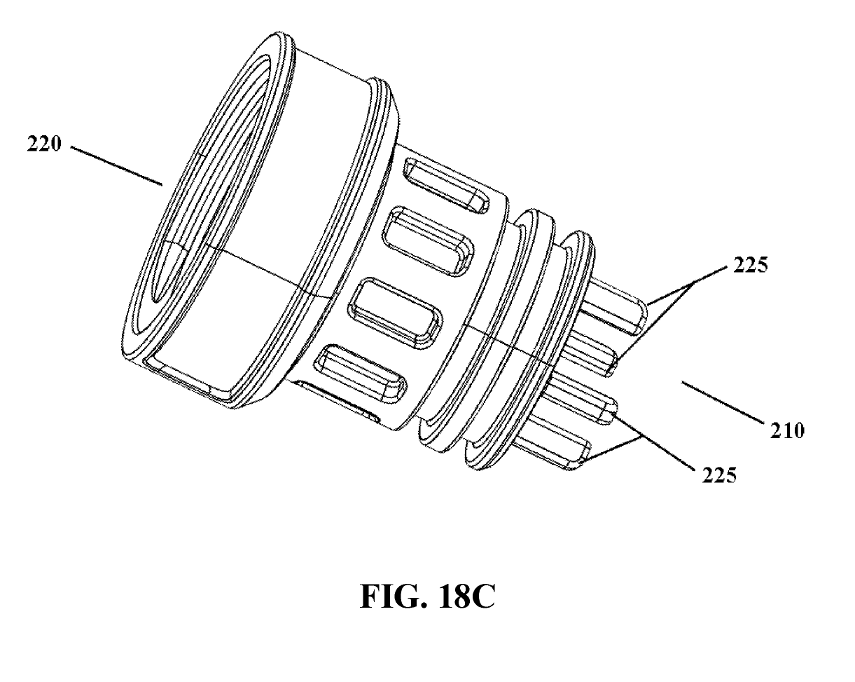

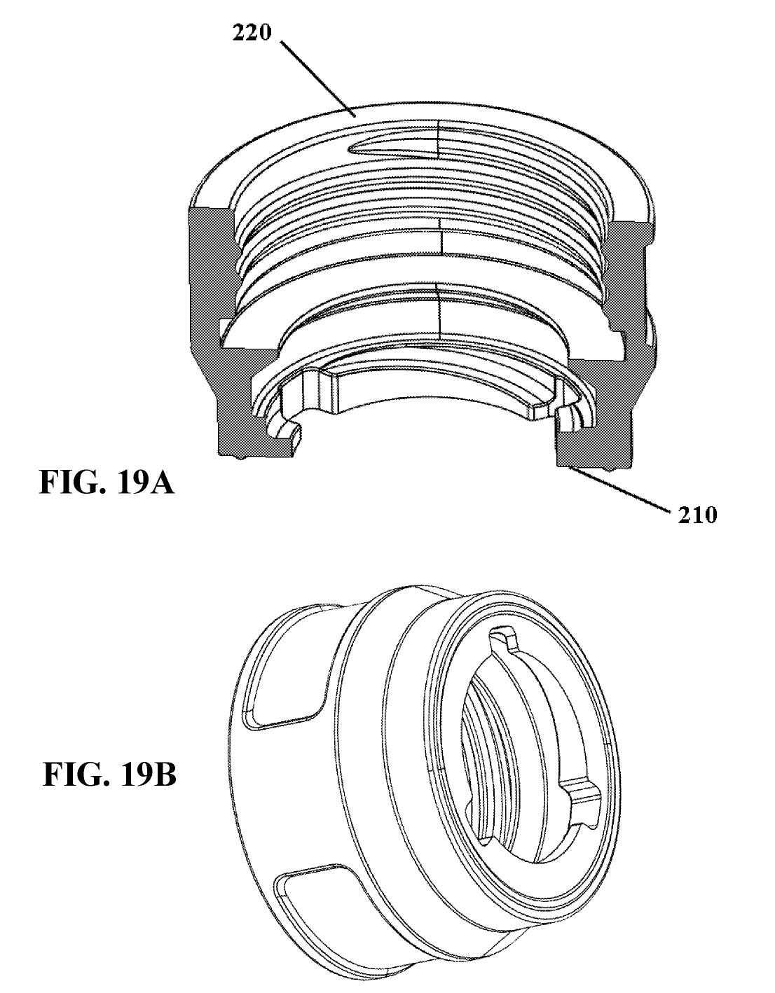

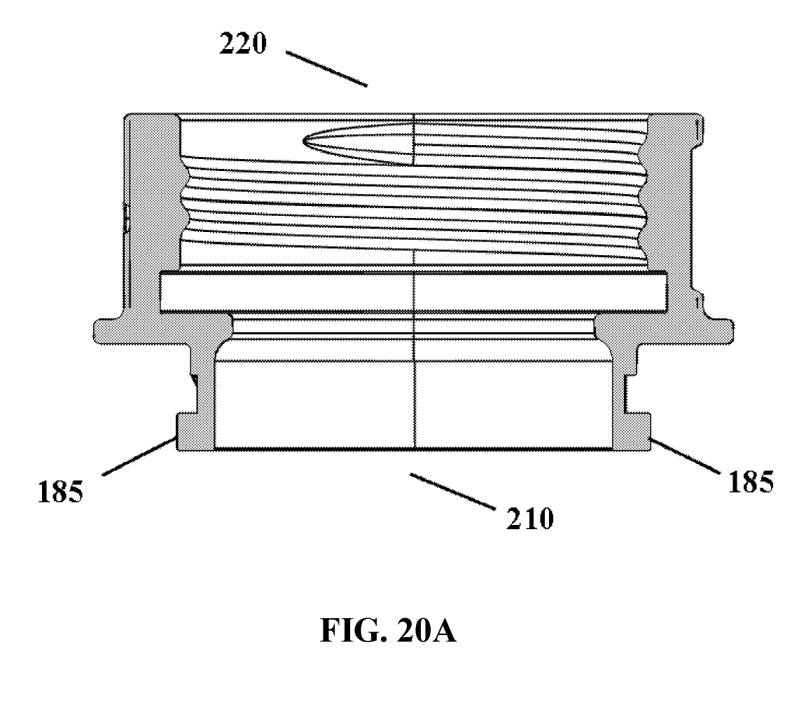

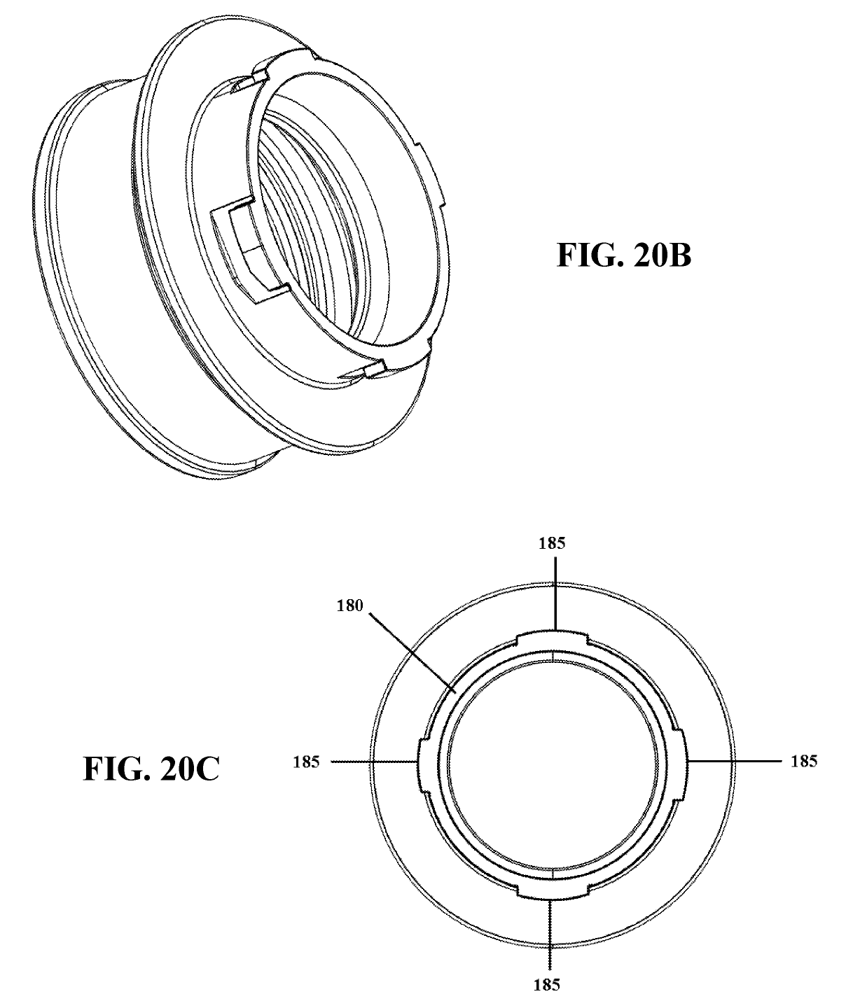

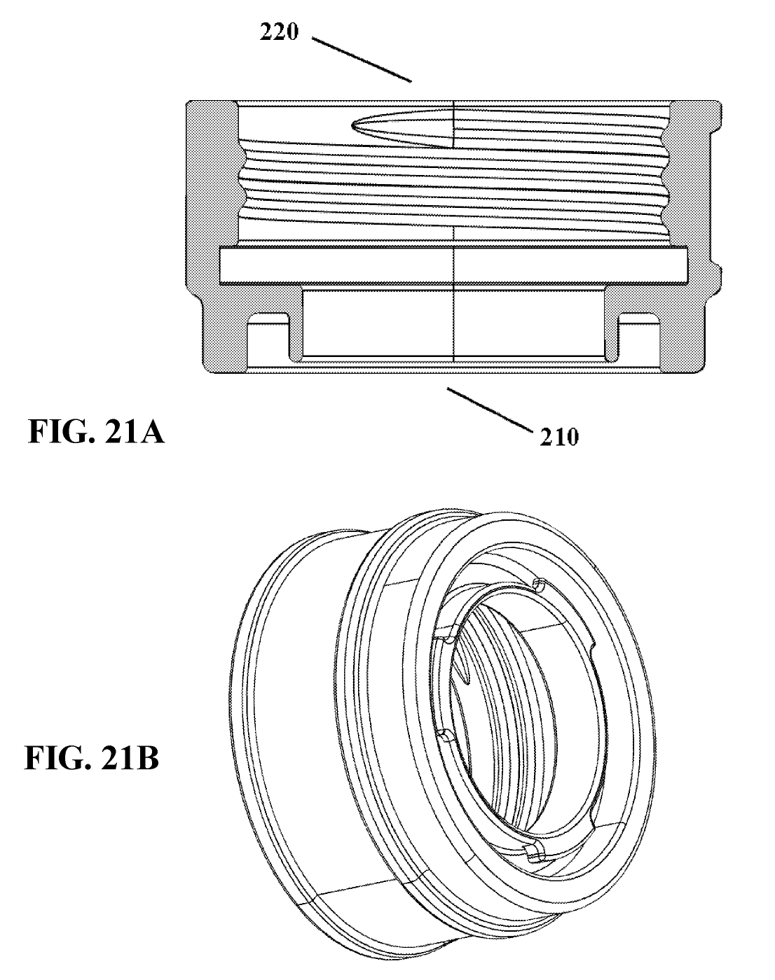

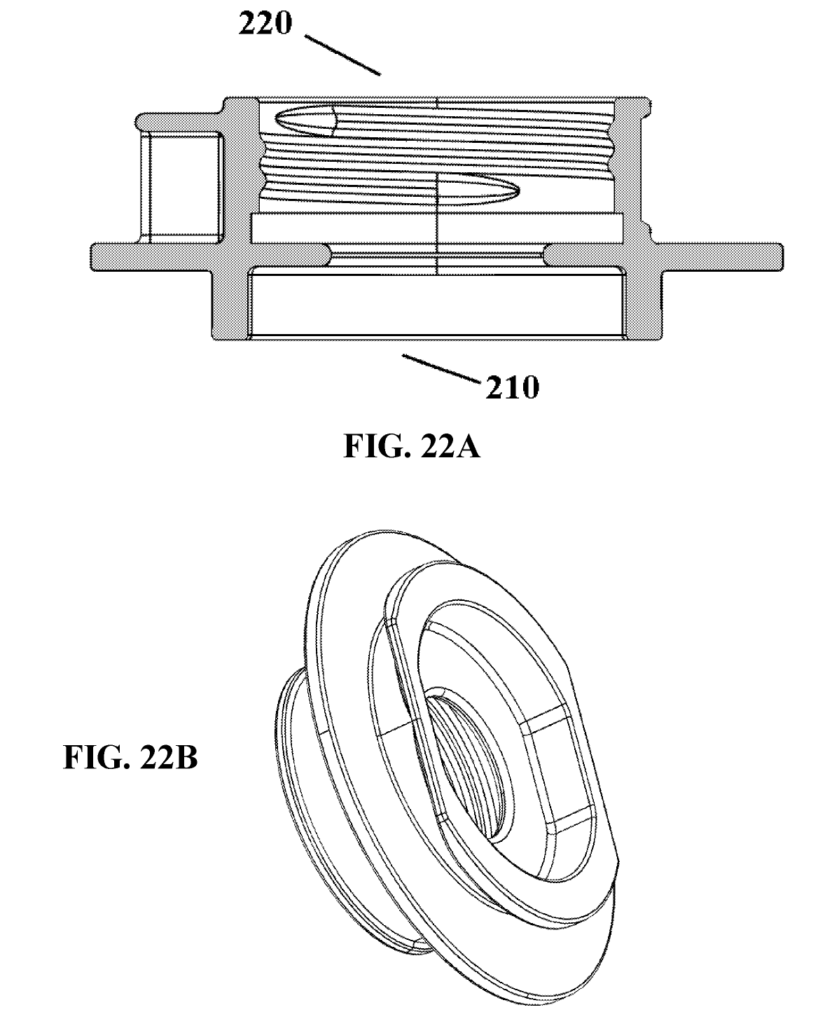

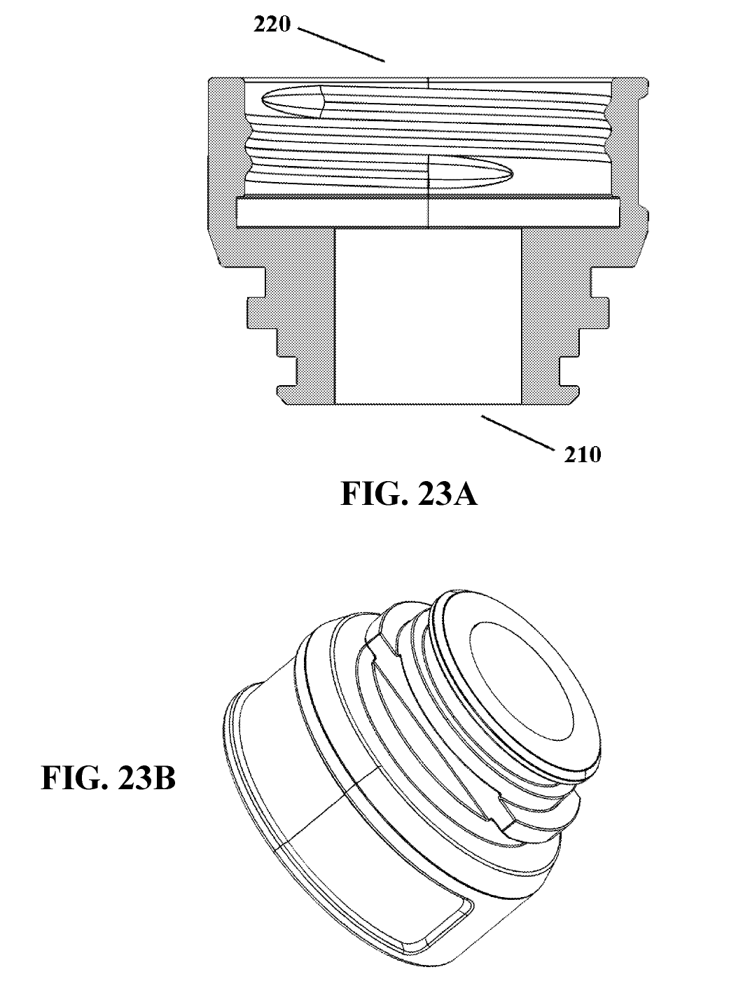

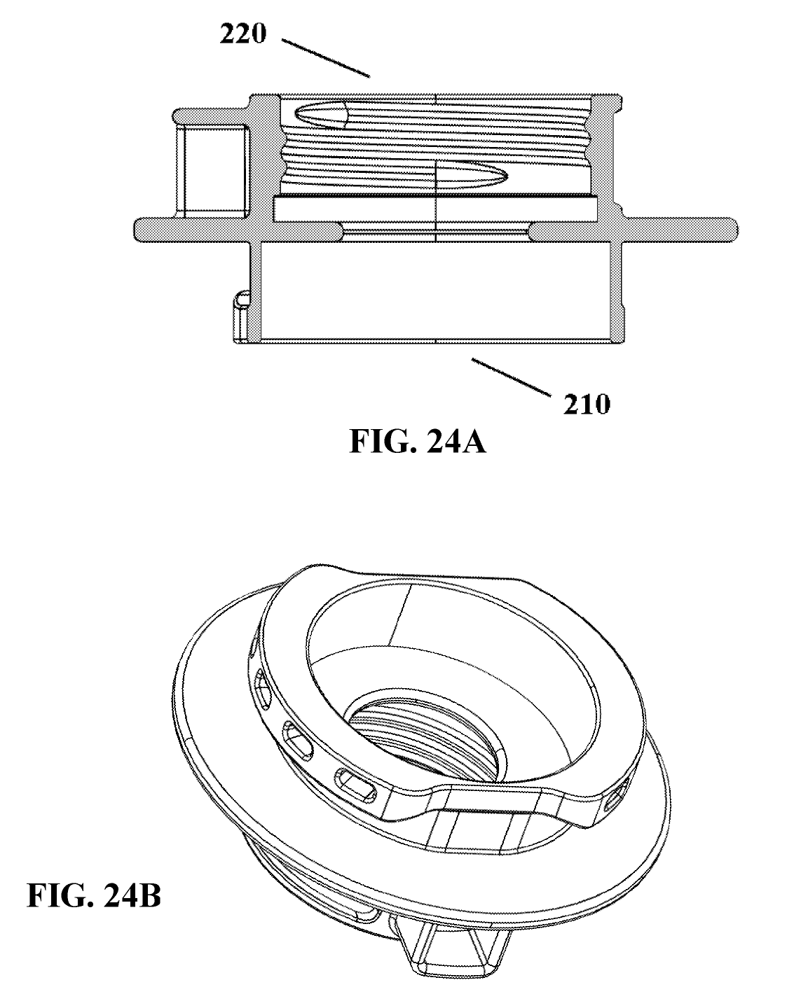

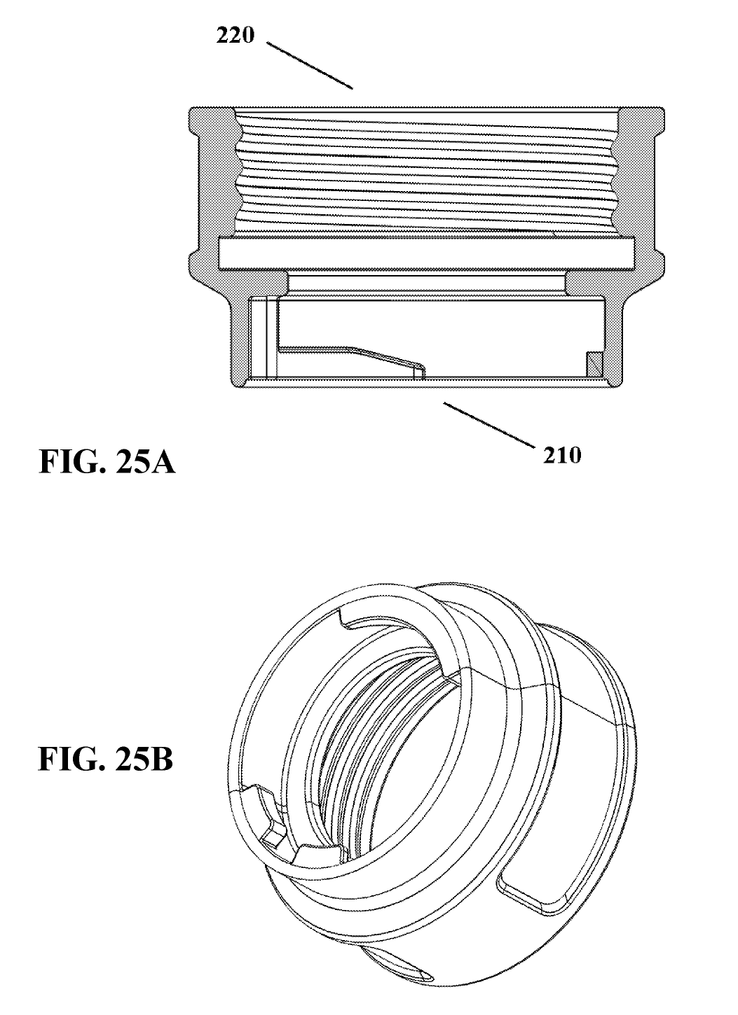

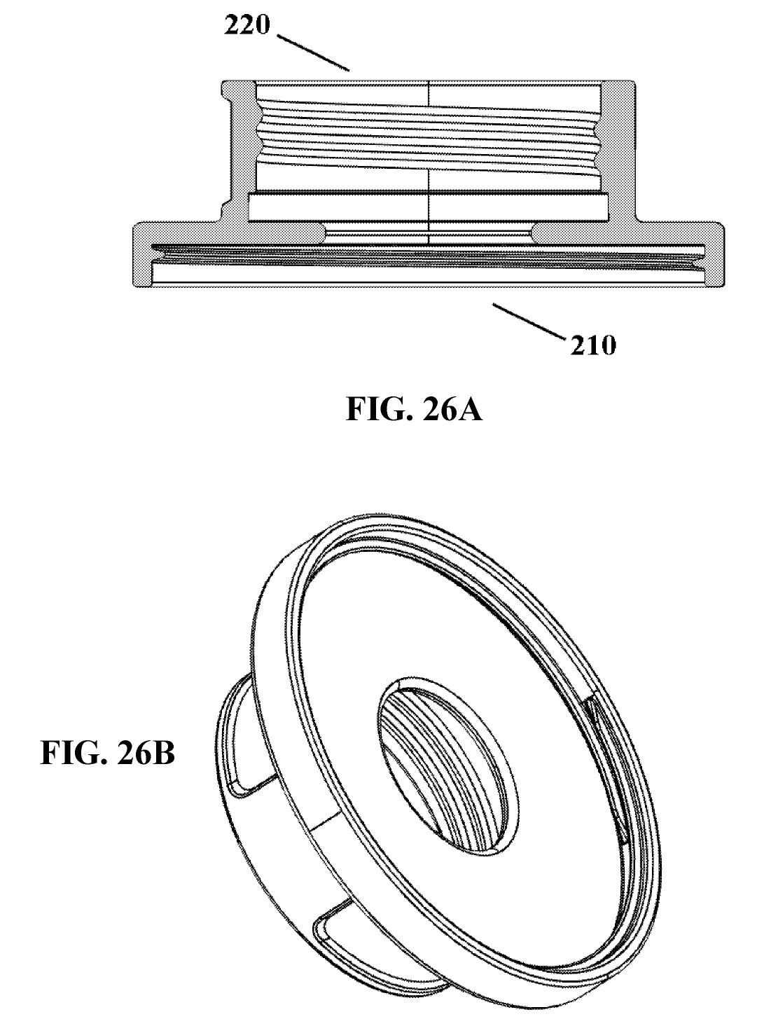

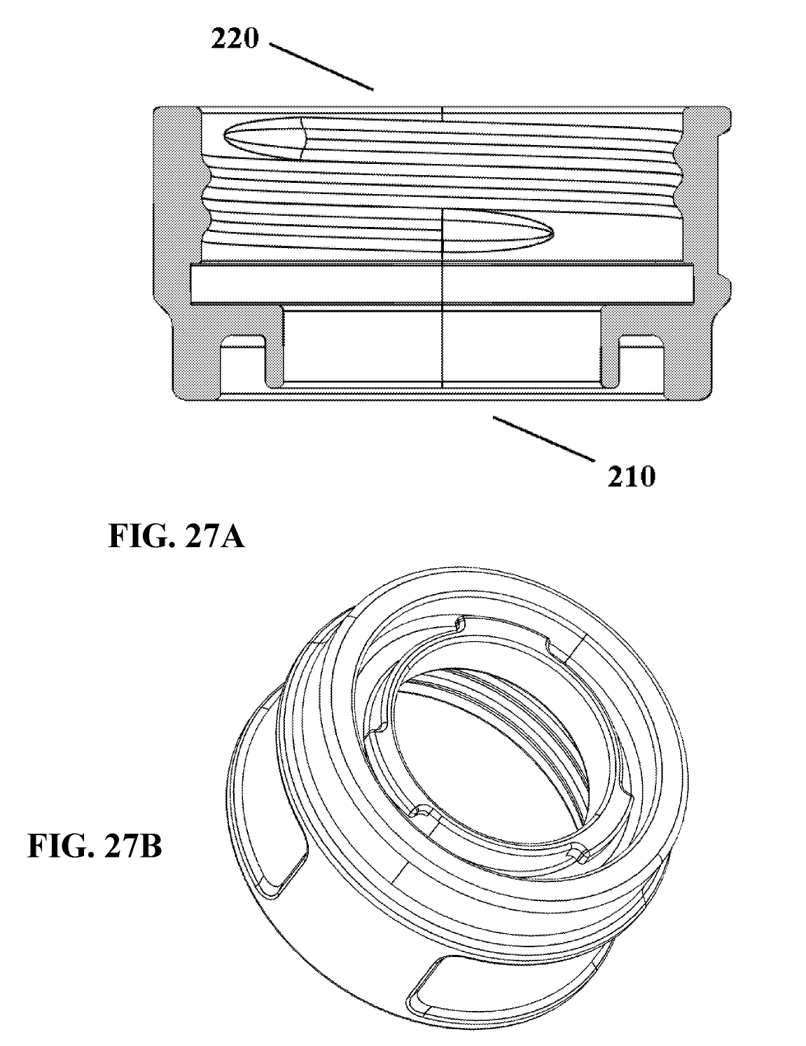

A bayonet connection 170 may include a bayonet B-lock attachment mechanism (FIGS. 25A-B). A bayonet connection 170 may include a three-peg bayonet attachment mechanism (FIGS. 19A-B). A bayonet connection 170 may include a four-peg bayonet attachment mechanism (FIGS. 20A-C). The bayonet connection 170 may be recessed within the adapter or converter (FIGS. 21A-B, 27A-B). The bayonet connection 170 may include a two-peg bayonet attachment mechanism (FIGS. 22A-B, 24A-B). The bayonet attachment mechanism 170 may include one or more cavities (FIG. 24B). The bayonet attachment mechanism 170 may include a DIN attachment mechanism (FIGS. 23A-B). The bayonet attachment mechanism 170 may include a quarter-turn attachment mechanism (FIGS. 17A-B). The quarter-turn attachment mechanism may be recessed.

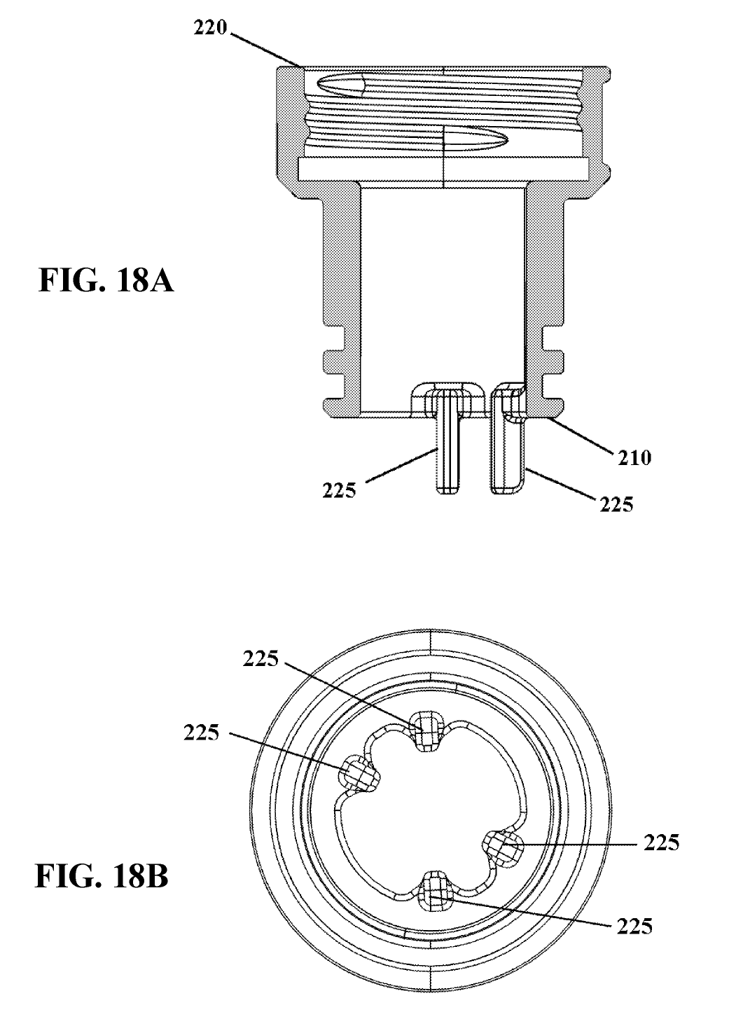

The attachment mechanism 170 may include one or more prongs of a desired length (FIGS. 18A-C).

The attachment mechanism 170 may include an attachment mechanism compliant with EN148-1 standards.

The attachment mechanism 170 may include a combination of two or more attachment mechanisms described herein.

While male threads, female threads, bayonet, and prong attachment mechanisms are described herein, other mechanisms of attaching the adapter 100 to the respirator, the adapter 100 to the converter 200, and the converter 200 to the respirator are possible and within the scope of the present disclosure. A converter 200 may include any corresponding attachment mechanism of a desired respirator.

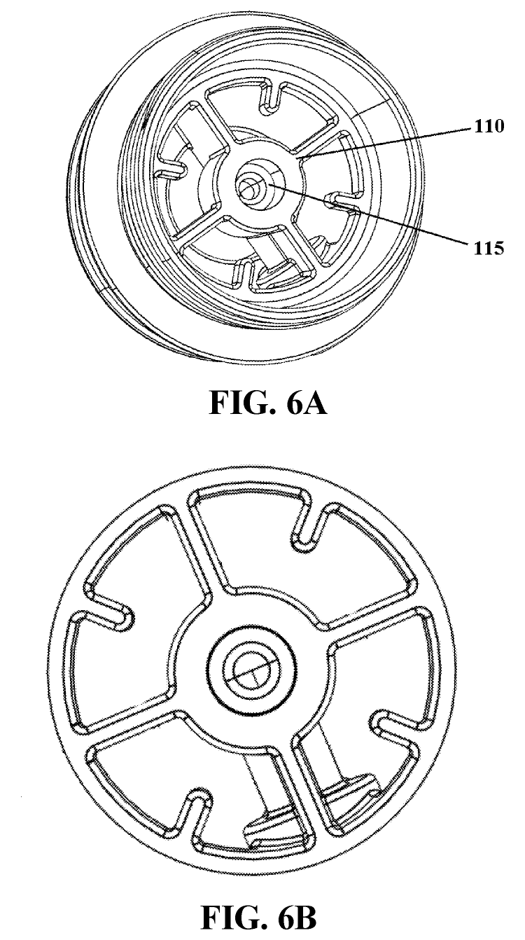

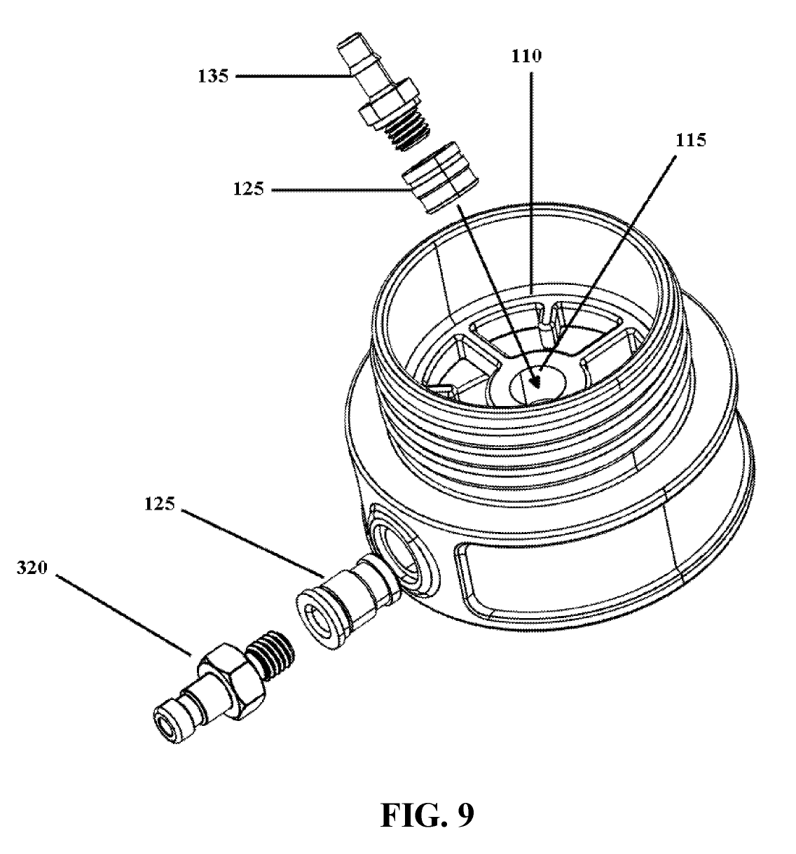

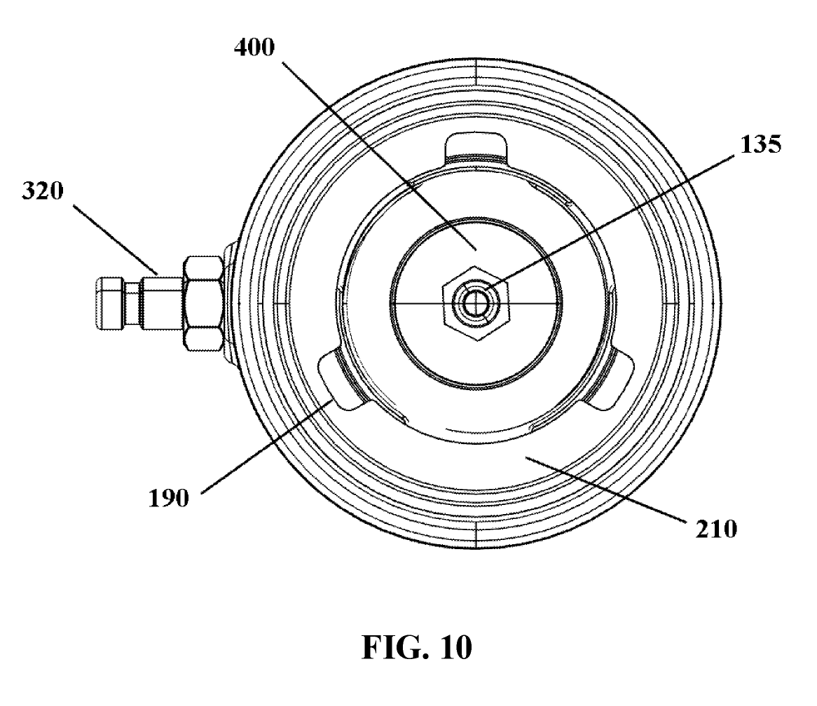

The adapter 100 may include a platform 110 (FIGS. 6A & 6B) having a platform opening 115 centrally located within the platform 110. The platform opening 115 may be configured to receive a metal insert 125 (FIG. 9). As a non-limiting example, a first end of the metal insert 125 may be attached to the platform opening 115, wherein the platform opening 115 is configured to receive the first end of the metal insert 125 (FIG. 9). The metal insert 125 may be heated to set the metal insert 125 into place within the platform opening, wherein the heat causes the material of the platform 110 to conform to the metal insert 125. A second end of the metal insert 125 may be configured to receive a first fitting 135 (FIG. 9). The material of the metal inserts and fittings of the present disclosure may include, but are not limited to, brass, plastic, aluminum, stainless steel, steel, combinations thereof, and the like. As a non-limiting example, the second end of the metal insert 125 may threadedly attached to the first fitting 135. The first fitting 135 may be any fitting known in the art that is capable of receiving a first respirator tubing 145. The first fitting 135, once attached to the metal insert, is centrally located or equidistant from the circumference of the platform 110 and/or equidistant from the circumference of an opening of the first end 120 of the adapter 100 (FIG. 10).

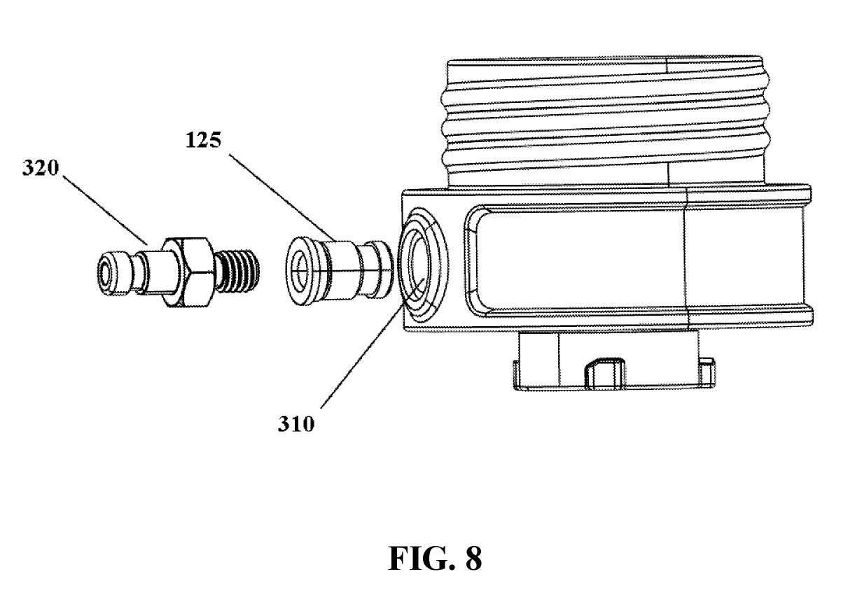

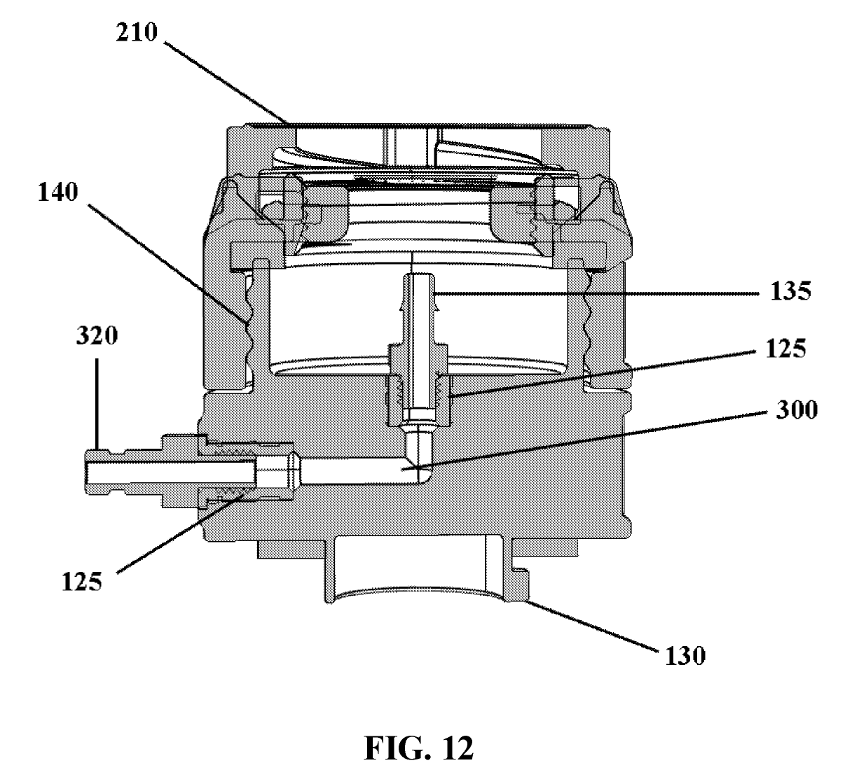

The adapter 100 may include an airtight channel 300 extending from the platform opening to an outlet 310 (FIG. 12). Accordingly, the adapters and/or converters of the present disclosure may not leak air into the channel other than through the ends of any tubing connected to fittings. The outlet 310 may be configured to receive a metal insert 125 (FIGS. 8-9). As a non-limiting example, a first end of the metal insert 125 may be attached to the outlet 310, wherein the outlet 310 is configured to receive the first end of the metal insert 125 (FIG. 8). The metal insert 125 may be heated to set the metal insert 125 into place within the outlet 310, wherein the heat causes the material of the outlet 310 to conform to the metal insert 125. A second end of the metal insert 125 may be configured to receive a second fitting 320 (FIG. 9). As a non-limiting example, the second end of the metal insert 125 may threadedly attached to the second fitting 320. While a metal insert 125 is described herein, any composition of an insert capable of attaching to a fitting is possible and within the scope of the present disclosure.

A second respirator tubing 147 may be attached to the second fitting 320 and a respirator fit test device. The second respirator tubing 147 may be of any desired length according to the distance from the fit test user to the respirator fit test device. The diameter, circumference, height, surface area, volume, and/or orientation of the chamber 300 may be changed depending upon the size of adapter and/or type of respirator or converter being used.

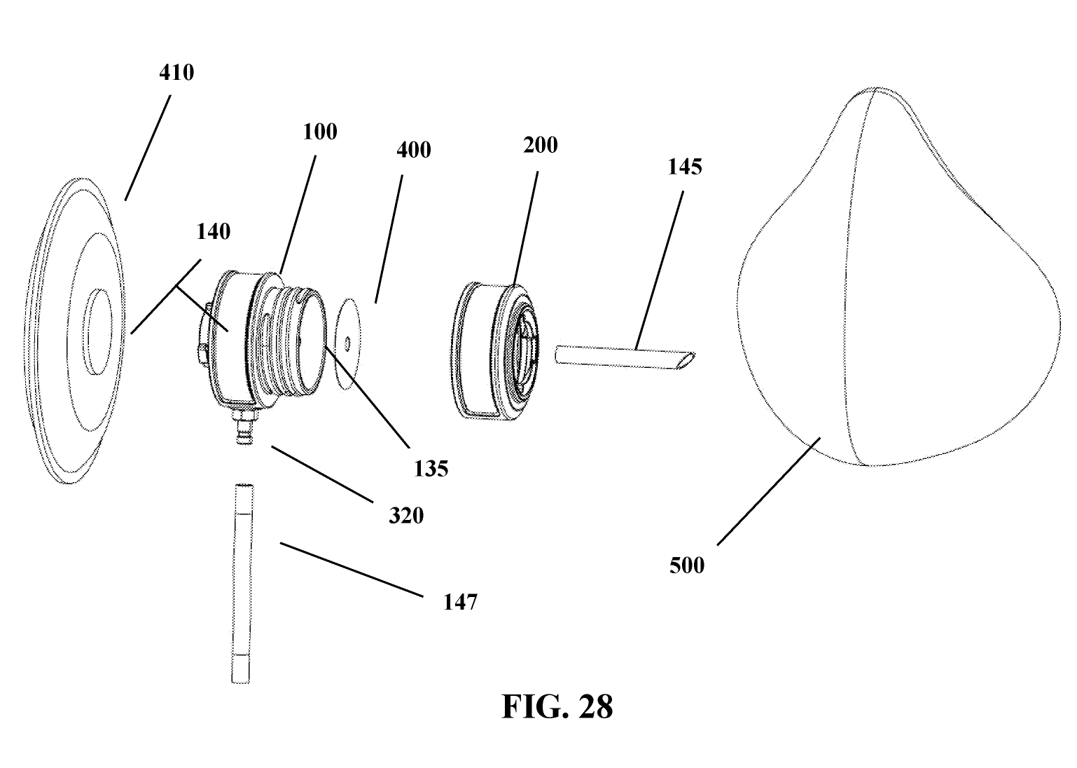

The first respirator tubing 145 may be of any length capable of attaching to the first fitting 135 and extending from the first fitting 135 into the respirator or extending from the first fitting 135 through the converter 200 and into the respirator (FIG. 28).

The platform 110 may be of any shape, circumference, or length capable of supporting the metal insert 125 and the first fitting 135, and in turn, the first respirator tubing 145 that is attachable to the first fitting 135 and extended from the first fitting 135 into the respirator 500, or extended from the first fitting 135 through the converter and into the respirator 500 (FIG. 28).

The platform 110 may be attached to the housing of the adapter 100 according to any method known in the art. As a non-limiting example, the platform 110 may be attached to the adapter via support columns to hold the base 110 and platform opening 115 in the opening of the adapter as shown in at least FIG. 6A. The platform 110 may be a separable part of the adapter 100, i.e., may include a connection element configure to couple the platform 110 within the adapter 100. Exemplary connection elements include at least threaded regions, snap-fit elements, interference fits between corresponding recessed and protruding regions, and the like. Alternatively, the platform 110 may be formed integrally with the adapter 100, i.e., is not a separate or removeable part. While a platform opening 115 has been described, any attachment mechanism of receiving the first fitting 135 known in the art is possible and within the scope of the present disclosure. Alternatively, the fitting 135 may be formed integrally with the platform 110, i.e., not a separate or removeable part requiring a metal insert 125.

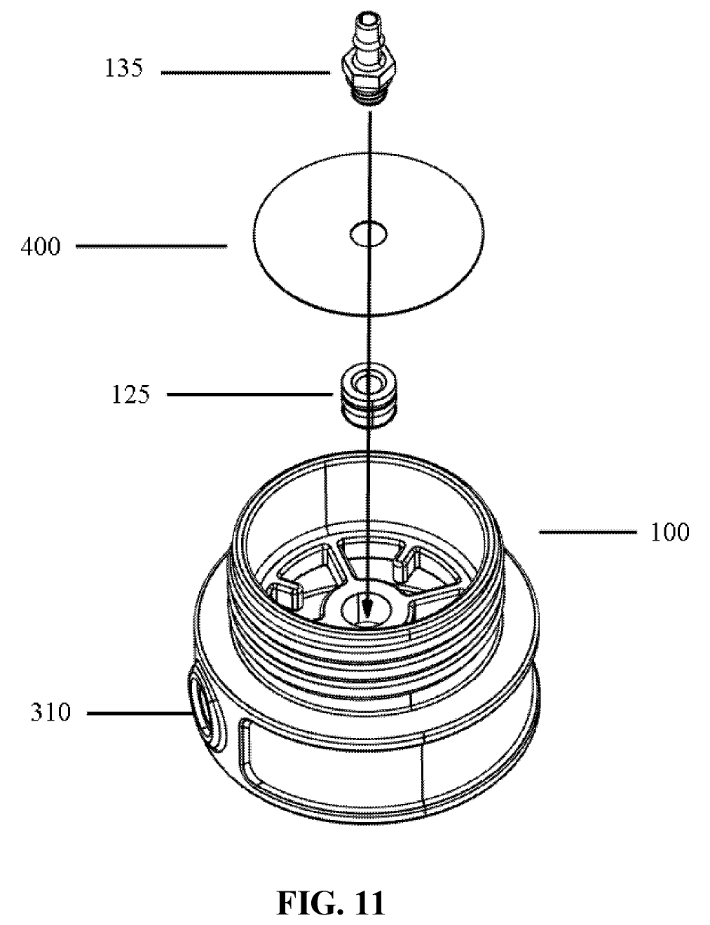

The adapter 100 may include a diaphragm 400 resting on the first end 120 side of the platform 110. The diaphragm 400 may be held in place by the metal insert 125 (FIGS. 10-11). The diaphragm 400 may act as an inhalation valve. The diaphragm 400 may be any composition known in the art capable of allowing the diaphragm to act as an inhalation valve, such as silicone.

The second end 130 of the adapter 100 may attach to a filter 410 via an attachment mechanism 140 described herein (FIG. 28, which illustrates a pancake filter). The filter 410 may include any filter known in the art compatible with a respirator and/or a respirator fit test. Respirator and/or filter manufacturers may include, but are not limited to, 3M, Airboss, AO Safety, Avon Protection, CleanSpace, Dentec, Draeger, Gerson, Glendale/Bilson, GVS, ISI, Interspiro, Lab Safety, Life Air, Miller, MSA, Moldex, North, Scott, Sundstrom, Survivair/Sperian, US Safety, and the like.

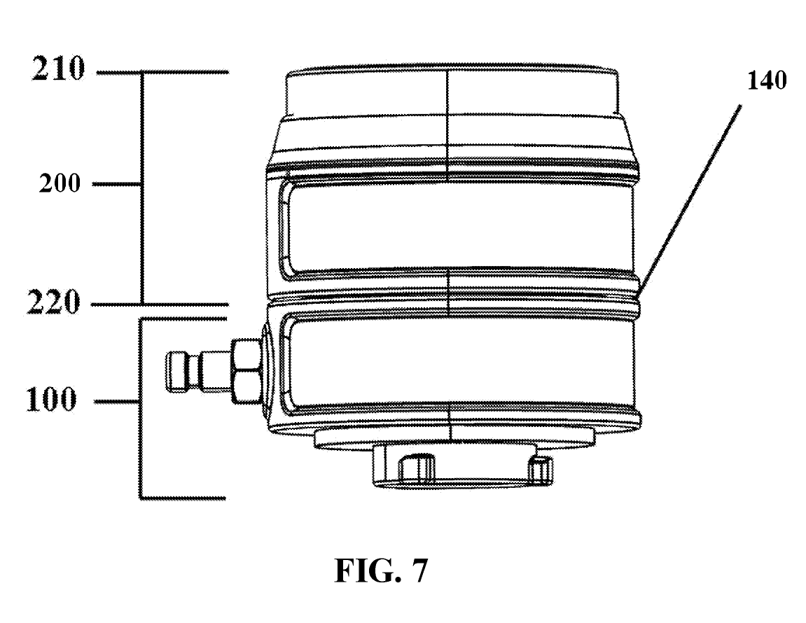

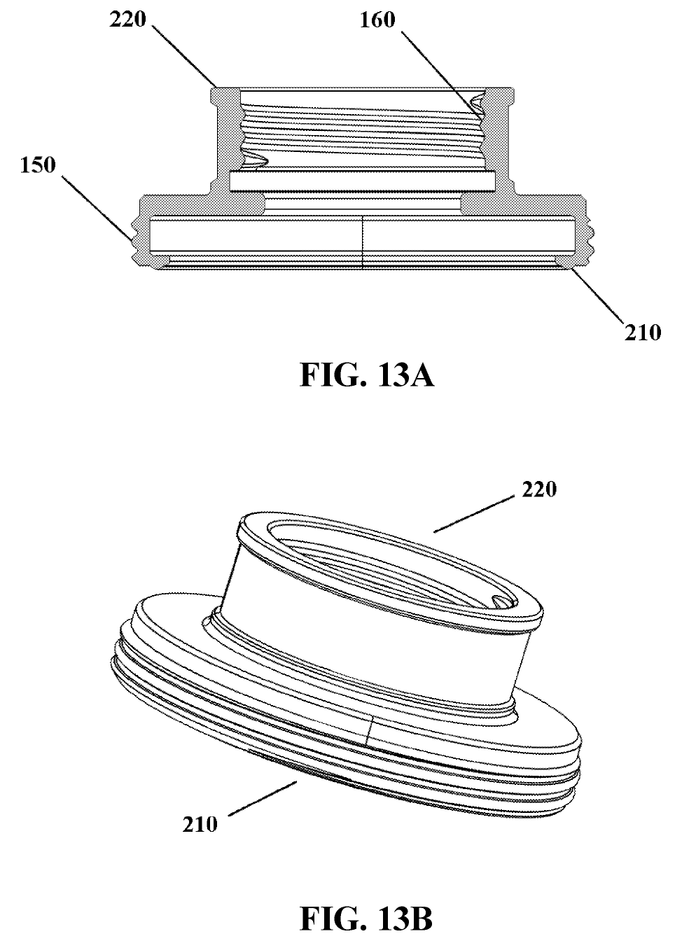

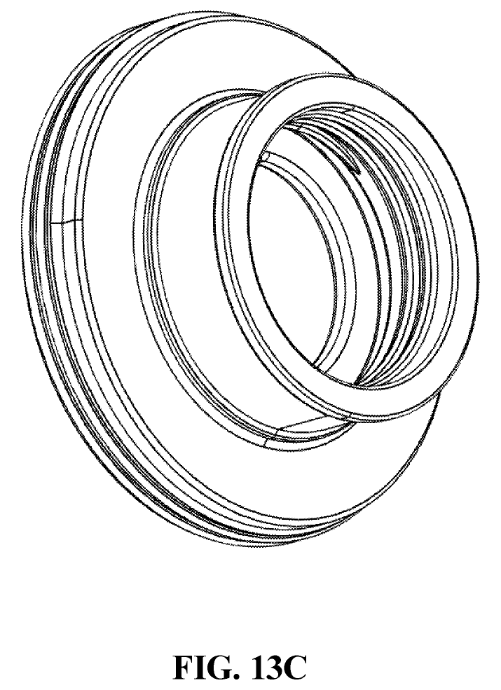

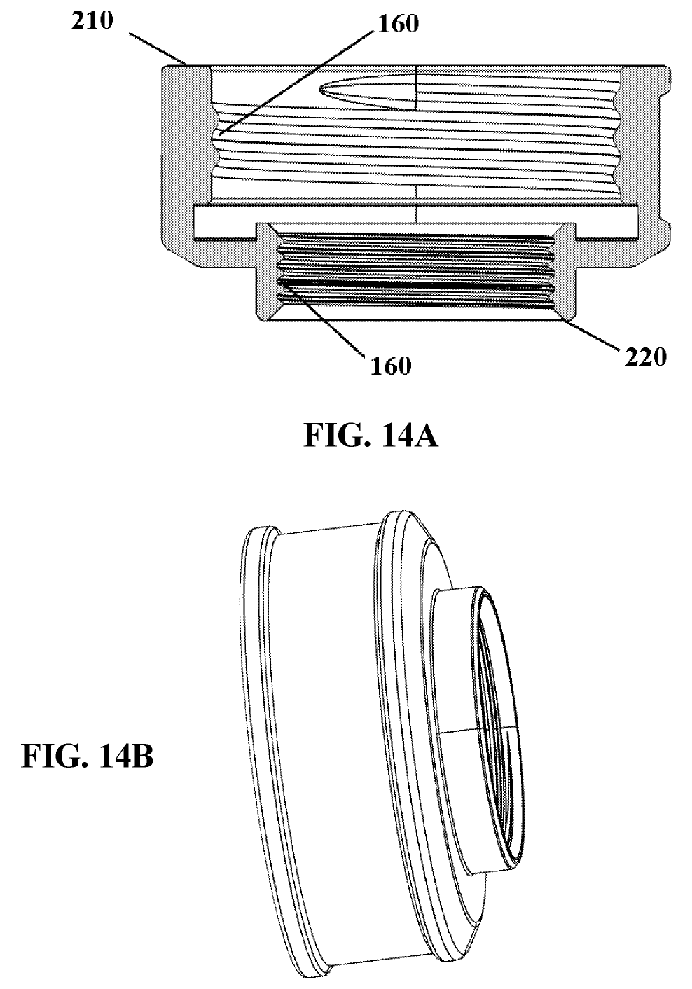

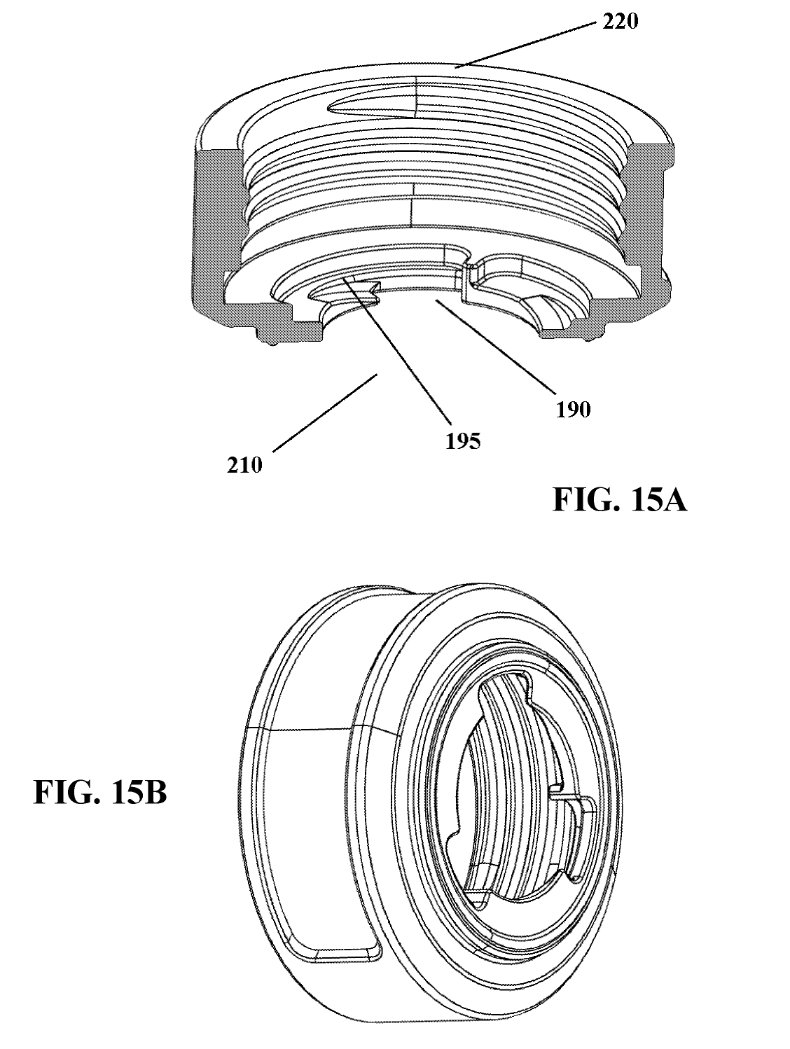

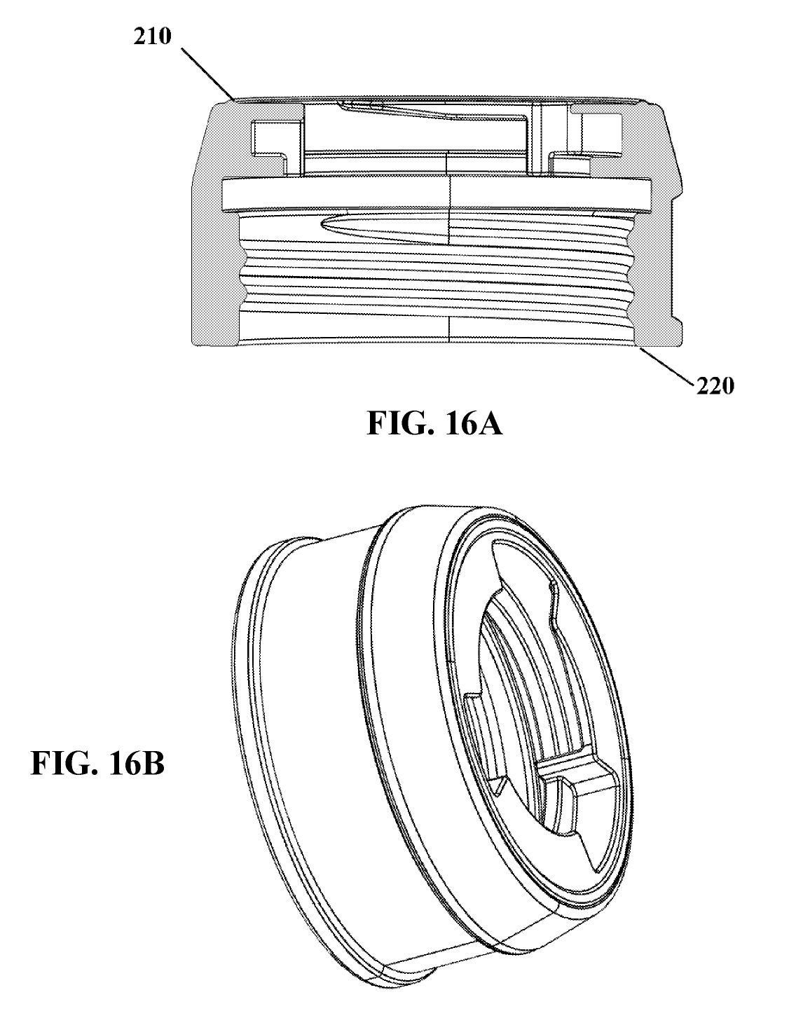

The converter 200 may include a first converter end 210 and a second converter end 220 (FIG. 7). The first converter end 210 may include an attachment mechanism 140 as described herein to attach the converter to a respirator. The first converter end 210 may include a female attachment mechanism corresponding to a male attachment mechanism of the respirator (e.g., FIGS. 14A-B, 15A-B, 16A-B, 19A-B, 25A-B, and 26A-B, and 26A-B). The first converter end 210 may include a male attachment mechanism corresponding to a female attachment mechanism of the respirator (e.g., FIGS. 13A-C, 17A-B, 18A-C, 20A-C, 21A-B, 23A-B, 24A-B, 22A-B, and 27A-B).

The second converter end 220 may include an attachment mechanism 140 as described herein to attach the adapter 100 to the converter 200 (FIG. 7). The converter 200 of the present disclosure may removably attach to the adapter 100. The first converter end 210 may include a female threaded attachment mechanism corresponding to a male threaded attachment mechanism of a respirator (FIGS. 14A, B and 26A-B). The first converter end 210 may include a male threaded attachment mechanism corresponding to a female threaded attachment mechanism of a respirator (FIGS. 13A-C). The first converter end 210 may include a male or female bayonet B-lock attachment mechanism corresponding to a female or male bayonet B-lock attachment mechanism of a respirator (FIGS. 25A-B). The first converter end 210 may include a male or female three-peg bayonet attachment mechanism corresponding to a female or male three-peg bayonet attachment mechanism of a respirator (FIGS. 19A-B). The first converter end 210 may include a male or female four-peg bayonet attachment mechanism corresponding to a female or male four-peg bayonet attachment mechanism of a respirator (FIGS. 20A-C). The first converter end 210 may include a recessed male or female bayonet attachment mechanism corresponding to a recessed female or male bayonet attachment mechanism of a respirator (FIGS. 21A-B, 27A-B). The first converter end 210 may include a male or female two-peg bayonet attachment mechanism corresponding to a female or male two-peg bayonet attachment mechanism of a respirator (FIGS. 22A-B, 24A-B). The two-peg bayonet attachment mechanism may include one or more cavities (FIG. 24B). The first converter end 210 may include a bayonet-DIN attachment mechanism corresponding to a bayonet-DIN attachment mechanism of a respirator (FIGS. 23A-B). The first converter end 210 may include a male or female quarter-turn attachment mechanism corresponding to a female or male quarter-turn attachment mechanism of a respirator (FIGS. 17A-B). The quarter-turn attachment mechanism may be recessed. The first converter end 210 may include one or more prongs of a desired length corresponding to an attachment mechanism of a respirator (FIGS. 18A-C).

The present disclosure may include an apparatus wherein a filter is removably attached to a second end of an adapter according to a first attachment mechanism, wherein the first attachment mechanism is any attachment mechanism described herein. The apparatus may further include a first end of the adapter removably attached to a second end of a converter according to a second attachment mechanism, wherein the second attachment mechanism is any attachment mechanism described herein. The apparatus may further include a first end of a converter removably attached to a respirator according to a third attachment mechanism, wherein the third attachment mechanism is any attachment mechanism described herein.

The shape and dimensions of the converter 200 may depend on the type of respirator and/or type of adapter. One of ordinary skill in the art may readily determine the shape and dimensions of a converter for a particular respirator or adapter. The present disclosure provides a universal adapter for any respirator necessary to conduct a respirator fit test by removably attaching a converter 200 to the adapter 100, wherein the first converter end 210 includes the appropriate attachment mechanism 140 corresponding to a specific respirator. The second converter end 220 includes the appropriate attachment mechanism 140 corresponding to the attachment mechanism of the first end 120 of the adapter. As a non-limiting example, a first end 120 of the adapter 100 having male 150 threads removably attaches to a second converter end 220 having female 160 threads.

The present disclosure provides a method of performing a respirator fit test utilizing the adapter 100 of the present disclosure. The method may include using an adapter and/converter for respirator fit testing according to the desired respirator and the attachment site of the desired respirator such that the first converter end 210 or the first end 120 of the adapter 100 corresponds to and removably attaches to the attachment site of the respirator.

The method may include threading a piece of tubing from the fitting of the adapter through a valve of the respirator. The method may include connecting a piece of tubing to the outlet and to the respirator fit test device. The method may include donning or putting on the respirator and performing a respirator fit test. The method may include trimming the tubing to an appropriate length depending on the distance from the first fitting 135 to the interior of the respirator. Performing the fit test may include performing a controlled negative pressure fit test.

The present disclosure provides methods of manufacturing an adapter and a converter of the present disclosure. Methods of manufacturing may include, but are not limited to, 3-Dimensional printing, laser printing, sintering, Computer Numerical Control (CNC) machining, and injection molding. Other manufacturing methods are possible and within the scope of the present disclosure.

The adapter and/or converter of the present disclosure may include any material or a combination of materials sufficient to provide adequate structural properties, including, but not limited to, sufficient stiffness and deformability to perform the methods of the present disclosure. The material or combination of materials may include polylactic acid, acrylonitrile butadiene styrene, plastic, polyvinyl alcohol plastic, polycarbonate, alumide, polyamide, resin, high-detail resin, paintable resin, transparent resin, stainless steel, aluminum, bronze, nickel, titanium, carbon fiber, graphene, nitinol, paper, polyvinyl chloride, any combination thereof, and the like.

The present disclosure provides a kit including one or more of an adapter of the present disclosure, a converter of the present disclosure, and a piece of tubing.

Conventional adapters for connecting a respirator to a respirator fit testing device require an adapter specific to each respirator brand or manufacturer, as each respirator brand or manufacturer may have a different attachment mechanism. This leads to significant costs and difficulties in obtaining an appropriate adapter for each respirator to be tested. The adapters and converters of the present disclosure provide a universal connection from a respirator to a respirator fit test device regardless of the respirator brand, type, or manufacturer.

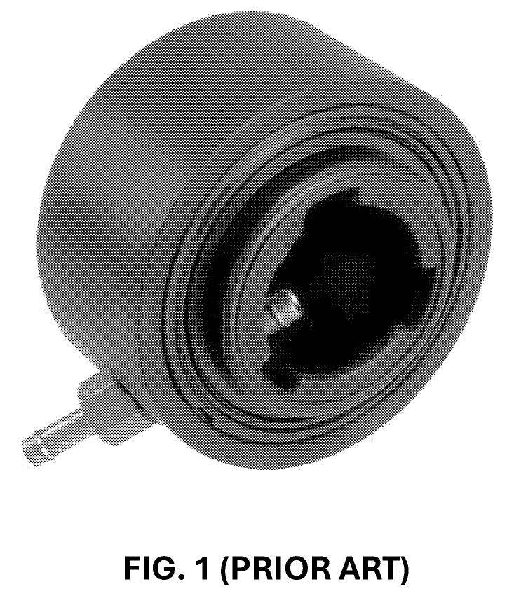

Conventional adapters or converters for respirator fit testing do not include a fitting centrally located or equidistant from the circumference of the platform and/or equidistant from the circumference of an opening of the first end of the adapter as described herein. The location of the fitting of the present disclosure provides advantages over conventional adapters. Conventional adapters may have the fitting located in an angled orientation inside the housing of the adapter (FIG. 1). An angled fitting is difficult for a user to access. Furthermore, an angled fitting may provide a less efficient path for any particles inside the respirator to travel into the tubing, through the adapter, and into the fit testing device. An angled fitting is not able to sufficiently hold a diaphragm in place during a respirator fit test, as an adapter with an angled fitting may rely on a ledge within the adapter housing to hold the diaphragm in place. Thus, conventional adapters have an increased chance of the diaphragm moving out of place, which may influence the respirator fit test.

The present disclosure provides improved adapters and converters with a centrally located fitting as described herein, thus addressing one or more of the problems known in the art. The adapters and/or converters of the present disclosure provide universal compatibility. The adapters and/or converters of the present disclosure sufficiently hold the diaphragm in place. The adapters and/or converters of the present disclosure provide an easier to access fitting to correctly and efficiently attach respirator tubing. The adapters and/or converters of the present disclosure may provide a fitting location that increases accuracy and/or efficiency of a respirator fit test.

Unlike conventional apparatuses and methods, the present disclosure enables a user without any prior experience to utilize an adapter and/or converter of the present disclosure to correctly perform a respirator fit test. The adapter and/or converter, and methods of the present disclosure provide an improved mechanism of action, which may solve one or more of the shortcomings in the art.

### Definitions

Unless otherwise defined, all terms (including technical and scientific terms) used herein have the same meaning as commonly understood by one of ordinary skill in the art to which this disclosure belongs. As such, terms, such as those defined by commonly used dictionaries, should be interpreted as having a meaning that is consistent with their meaning in a context of a relevant art and should not be interpreted in an idealized or overly formal sense unless expressly so defined herein.

As used herein, the term “Controlled Negative Pressure” or “CNP” refers to a quantitative fit testing method utilizing negative pressure as a direct measure of respirator leakage using air as the test challenge agent. CNP is based on exhausting air from a temporarily sealed respirator facepiece to generate and then maintain a constant negative pressure inside the facepiece, wherein the rate of air exhaust is controlled such that a constant negative pressure is maintained in the respirator during the fit test. With constant pressure, air flow out of the respirator is equal to air flow into the respirator.

As used herein, the term “adapter” may be used to refer to any device capable of attaching and/or connecting a respirator to a fit testing device.

As used herein, “respirator tubing” and “tubing” are used interchangeably and may refer to any type of tubing used during respirator fit testing.

As used herein, the term “valve” may be used to refer to any valve of a respirator, including, but not limited to, a butterfly-type popper valve, an exhalation valve, a diaphragm-type valve, a controlled air valve, an inhalation valve, and the like. A valve may include one or more partitions or spokes extending radially from a central axis of the valve.

As used herein, the term “respirator” refers to, but is not limited to, a tight-fitting respirator, an air-purifying respirator, a supplied-air respirator, an elastomeric half facepiece respirator, an elastomeric full facepiece respirator, a filtering facepiece respirator, a powered air-purifying respirator, a supplied-air respirator, a self-contained breathing apparatus, or a combination respirator.

As used herein, the term “and/or” includes any and all combinations of one or more of the associated listed items. Likewise, as used in the following detailed description, the term “or” is intended to mean an inclusive “or” rather than an exclusive “or.” That is, unless specified otherwise, or clear from context, “X employs A or B” is intended to mean nay of the natural inclusive permutations. Thus, if X employs A; X employs B; or X employs both A and B, then “X employs A or B” is satisfied under any of the foregoing instances.

The terminology used herein is for the purpose of describing particular examples only and is not intended to be limiting. As used herein, the singular forms “a,” “an,” and “the” may be intended to include the plural forms as well, unless the context clearly dictates otherwise. As example, “a” converter may comprise one or more converters, and the like.

The terms “comprises”, “comprising”, “including”, “having”, and “characterized by”, may be inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms may be to be understood as a non-restrictive term used to describe and claim various aspects set forth herein, in certain aspects, the term may alternatively be understood to instead be a more limiting and restrictive term, such as “consisting of” or “consisting essentially of.” Thus, for any given aspect reciting compositions, materials, components, elements, features, integers, operations, and/or process steps, described herein also specifically includes aspects consisting of, or consisting essentially of, such recited compositions, materials, components, elements, features, integers, operations, and/or process steps. In the case of “consisting of”, the alternative aspect excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics may be excluded from such an aspect, but any compositions, materials, components, elements, features, integers, operations, and/or process steps that do not materially affect the basic and novel characteristics may be included in the aspect.

Any method steps, processes, and operations described herein may not be construed as necessarily requiring their performance in the particular order discussed or illustrated, unless specifically identified as an order of performance. It is also understood that additional or alternative steps may be employed, unless otherwise indicated.

In addition, features described with respect to certain example aspects may be combined in or with various other example aspects in any permutational or combinatory manner. Different aspects or elements of example aspects, as disclosed herein, may be combined in a similar manner. The term “combination,” “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Words such as “then,” “next,” etc. are not intended to limit the order of the steps; these words may be simply used to guide the reader through the description of the methods.

In the description, certain details are set forth to provide a better understanding of various aspects of the systems and methods disclosed herein. However, one skilled in the art will understand that these aspects may be practiced without these details and/or in the absence of any details not described herein. In other instances, well-known structures, methods, and/or techniques associated with methods of practicing the various aspects may not be shown or described in detail to avoid unnecessarily obscuring descriptions of other details of the various aspects.

While specific aspects of the disclosure have been provided hereinabove, the disclosure may, however, be embodied in many different forms and should not be construed as necessarily being limited to only the aspects disclosed herein. Rather, these aspects may be provided so that this disclosure is thorough and complete, and fully conveys various concepts of this disclosure to skilled artisans.

Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

All numerical quantities stated herein may be approximate, unless stated otherwise. Accordingly, the term “about” may be inferred when not expressly stated. The numerical quantities disclosed herein may be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5-fold or 2-fold of a given value. Notwithstanding the approximations of numerical quantities stated herein, the numerical quantities described in specific examples of actual measured values may be reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges may be continuous and include every value between the minimum and maximum values. Any maximum numerical limitation recited herein is intended to include all lower numerical limitations. Any minimum numerical limitation recited herein is intended to include all higher numerical limitations.

Features or functionality described with respect to certain example aspects may be combined and sub-combined in and/or with various other example aspects. Also, different aspects and/or elements of example aspects, as disclosed herein, may be combined and sub-combined in a similar manner as well. Further, some example aspects, whether individually and/or collectively, may be components of a larger system, wherein other procedures may take precedence over and/or otherwise modify their application. Additionally, a number of steps may be required before, after, and/or concurrently with example aspects, as disclosed herein. Note that any and/or all methods and/or processes, at least as disclosed herein, may be at least partially performed via at least one entity or actor in any manner.

All documents cited herein may be incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular aspects have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application, including the appended claims, is therefore intended to cover all such changes and modifications that may be within the scope of this application.

### Aspects

Aspect 1: A system configured to provide universal connection between a respirator and a respirator fit testing device as shown and described herein.

Aspect 2: A method of manufacturing a system configured to provide universal connection between a respirator and a respirator fit testing device as shown and described herein.

Aspect 3: A method of using a system configured to provide universal connection between a respirator and a respirator fit testing device as shown and described herein.

Aspect 4: A system comprising: an adapter having a second end configured for removable attachment to a filter; and a converter having a first end configured for removeable attachment to a respirator and a second end configured for removeable attachment to a first end of the adapter, wherein the system provides connection between a respirator and a respirator fit testing device.

Aspect 5: The system according to any of the foregoing aspects, wherein the adapter comprises an air-tight channel having a first open end positioned centrally within the first end of the adapter and a second open end positioned on a circumferential side of the adapter.

Aspect 6: The system according to any of the foregoing aspects, wherein the first open end of the channel is configured to accept a length of a first tubing that extends into the respirator when the system is attached to the respirator.

Aspect 7: The system according to any of the foregoing aspects, wherein the first open end of the channel is configured to accept a first fitting, wherein a length of a first tubing is attachable at a first end thereof to the first fitting, and a second end of the length of the first tubing is configured to extend into the respirator when the system is attached to the respirator.

Aspect 8: The system according to any of the foregoing aspects, wherein the second open end of the channel is configured to accept a length of a second tubing that provides connection to the fit test apparatus.

Aspect 9: The system according to any of the foregoing aspects, wherein the second end of the channel is configured to accept a second fitting, wherein a second length of a second tubing is attachable at a first end thereof to the second fitting, and a second end of the second length of the second tubing is configured for connection to the fit test apparatus.

What is claimed is:

1. A system comprising:
an adapter having a second end configured for removable attachment to a filter; and
a converter having a first end configured for removeable attachment to a respirator and a second end configured for removeable attachment to a first end of the adapter,
wherein the system provides connection between a respirator and a respirator fit testing device.

2. The system of claim 1, wherein the adapter comprises an air-tight channel having a first open end positioned centrally within the first end of the adapter and a second open end positioned on a circumferential side of the adapter.

3. The system of claim 2, wherein the first open end of the channel is configured to accept a first fitting, wherein a length of a first tubing is attachable at a first end thereof to the first fitting, and a second end of the length of the first tubing is configured to extend into the respirator when the system is attached to the respirator.

4. The system of claim 2, wherein the second end of the channel is configured to accept a second fitting, wherein a second length of a second tubing is attachable at a first end thereof to the second fitting, and a second end of the second length of the second tubing is configured for connection to a fit test apparatus.
